(19) United States
(12) Patent Application Publication
(10) Pub. No.: US 2012/0293719 A1
(43) Pub. Date: Nov. 22, 2012

(54) LIGHTING DEVICE, DISPLAY DEVICE AND TELEVISION RECEIVER

(75) Inventor: Kazuhiko Negoro, Osaka-shi (JP)

(73) Assignee: Sharp KabushikiI Kaisha, Osaka-shi, Osaka (JP)

(21) Appl. No.: 13/522,770

(22) PCT Filed: Dec. 7, 2010
(86) PCT No.: PCT/JP2010/071866

§ 371 Date: Jul. 18, 2012

(30) Foreign Application Priority Data
Jan. 19, 2010 (JP) 2010-008887

(51) Int. Cl. H04N 5/44; F21V 29/00; G02F 1/13357; F21V 8/00

(52) U.S. Cl. 348/725; 362/612; 362/602; 349/65; 348/E05.096

(57) ABSTRACT

A property of dissipating heat generated from a light source in an edge light type lighting device is improved. A lighting device includes: a plurality of LEDs 17; a chassis 14 housing the LEDs 17; light guide members 21 housed in the chassis 14 and including light entrance surfaces 21a through which light from the LEDs 17 enters and light output surfaces 21b from which the light exits; and a plurality of heat pipes 30 fixed on the chassis 14. The chassis 14 has a substantially rectangular bottom plate, and the LEDs 17 are arranged in a line on at least one of short sides of a bottom plate 14a of the chassis 14. The heat pipes 30 are formed in an elongated shape having one end that overlaps the LEDs 17 and another end that is provided on a middle portion of the chassis 14 in a longitudinal direction thereof.

### TECHNICAL FIELD

The present invention relates to a lighting device, a display device, and a television receiver.

### BACKGROUND ART

In recent years, display elements of an image display device, such as a television receiver, have been shifted from the conventional cathode-ray tube to thin display panels, such as liquid crystal panels or plasma display panels. This enables the image display device to have a reduced thickness. A liquid crystal panel does not emit light, and therefore a backlight unit is required as a separate lighting device. The backlight unit is provided on a back side (opposite side to a display surface) of the display panel and includes a metal chassis having an opening on a display panel side surface and a light source housed in the chassis.

As a means of making the backlight unit thinner, an edge light type backlight unit is known. In the edge light type, the light source is disposed on a peripheral portion of the chassis. The light from the light source enters a light guide plate to convert into planar light, and which is supplied to the display panel. As the light source, a LED maybe preferably used due to its advantages such as low power consumption. However, in order to obtain a required amount of light in the edge light type, a number of LEDs needs to be mounted in high density. Thus, the temperature around the LEDs tends to increase, resulting in a decrease in light emission efficiency of the LEDs or their thermal degradation, for example. A solution for this problem is proposed in Patent Document 1.

In the backlight unit according to Patent Document 1, a drive circuit board with a plurality of LEDs mounted thereon is held between a pair of heat conducting members. This configuration dissipates heat generated by the LEDs quickly outside the backlight unit via the drive circuit board and the heat conducting members.

Patent Document 1: Japanese Unexamined Patent Publication No. 2007-12416

### Problem to be Solved by the Invention

However, as a result of an increase in size of the display device, a number or size of the light sources is increased, and thereby intervals between the light sources become narrower, which leads to increase an amount of heat generated per unit area around the light sources. Accordingly, the means according to Patent Document 1 may not provide a sufficient heat dissipating capability.

### DISCLOSURE OF THE PRESENT INVENTION

The present invention was made in view of the foregoing circumstances and an object of the present invention is to improve a property of dissipating heat from the light source in an edge light type lighting device.

### Means for Solving the Problem

A lighting device according to the present technology includes a plurality of LEDs; a chassis including substantially a rectangular bottom plate and housing the LEDs such that the LEDs are arranged along an at least a short side of the bottom plate; a light guide member housed in the chassis and including a light entrance surface through which light from the LEDs enters and a light exit surface from which the light exits, the light guide member being provided such that the light entrance surface faces the LEDs; and a plurality of cooling members fixed on the chassis and formed in an elongated shape having one end that is provided to overlap one of the LEDs and another end that is provided in a middle portion of the chassis in a longitudinal direction thereof.

A configuration of the edge light type, in which LEDs are arranged in a line on a peripheral portion of the chassis and the light is output via a light guide body, is excellent as a means of providing a thin lighting device. However, in this configuration, the LEDs are arranged in high density. As a result of the concentration of the LEDs as a heat source, high temperature tends to occur locally. However, according to the present invention, in such an edge light type, the elongated cooling members is disposed in such a manner that one end thereof overlaps with the LEDs and the other end extends to the middle portion of the chassis with respect to the longitudinal direction thereof, thereby facilitating dissipation of the heat. Namely, the heat is sufficiently absorbed by the cooling members overlapping with the LEDs, and the absorbed heat is transferred via the cooling members to the middle portion of the chassis where temperature is lower. Thus, the heat can be efficiently dissipated. By providing a plurality of cooling members, an amount of heat dissipated per cooling members is reduced, improved heat circulation efficiency in the cooling members is obtained, and the cooling efficiency with respect to the individual LEDs is improved.

Preferred embodiments of the present technology include the following.

(1) The cooling members may be heat pipes. By using the heat pipes utilizing vaporization heat of a refrigerant as the cooling members, a high heat dissipating capability can be obtained. The heat pipes are operable without electric power, so that lower power consumption can be achieved compared to the case of using a blower fan or the like.

(2) The LEDs may be arranged on a first surface of the bottom plate and the cooling members maybe fixed on a second surface of the bottom plate that is opposite to the first surface. The cooling members are provided on the second surface of the bottom that is a surface opposite to the first surface on which the LEDs are arranged, i.e., outside of the lighting device. This saves space within the lighting device. If the cooling members absorb the heat generated by the LEDs and dissipate some of the heat directly to the outside air, higher air circulation efficiency can be obtained on the outside of the lighting device than inside thereof. Thus, in the configuration according to the present technology a high heat dissipating capability can be obtained.

(3) The cooling members may be fixed to the chassis with a double-sided tape having high heat conductivity. This configuration allows the cooling members to be easily installed, resulting in high installation workability. The heat conducted to the cooling members is dissipated not only via the dissipating mechanism of the cooling members, but also to the chassis via the surface portion of the cooling members fixed to the chassis with the double-sided tape. Further, by fixing the cooling members with the double-sided tape, the cooling members have a larger contact area with the chassis compared to using other fixing means. Thus, the heat dissipating capability of the cooling members via the chassis can be further improved.

(4) The LEDs may be arranged on each short-side end portion of the chassis in a line along a short side of the chassis. In this configuration, improved brightness is obtained compared with the case where the LEDs are disposed on only one of the short sides of the chassis.

(5) The lighting device may further include: an LED board on which the LEDs are mounted; and a heatsink connected to the LED board. The light guide member may include a plurality of light guide members that are arranged along an arrangement of the LEDs. The LED board may extend along an arrangement of the light guide members. The heatsink may be connected to the one end of the cooling member that is close to the LEDs. By mounting the LEDs on the LED board, the installation of the LEDs and the wiring between the LEDs can be simplified. Further, in the above configuration, the heat generated by the LEDs is conducted to the heatsink connected to the LED board and then to the plurality of cooling members connected to the heatsink. By thus connecting the cooling members to the heatsink, the heat dissipating efficiency of the heatsink is further improved. Accordingly, the dissipating capability of the heat from the LEDs can be improved.

(6) The light guide body may include a plurality of light guide members arranged along an arrangement of the LEDs. In this configuration, output of the light from the light guide member is independently controlled per light guide member. Therefore, an area active control per light guide member can be performed.

(7) Each one of the LEDs may be provided for each light entrance surface of the light guide members. By thus providing one light guide member corresponding to one LED that is the minimum unit of LED drive control, the effect of the area active control can be maximized.

Next, to solve the above problem, a display device of the present technology includes the lighting device described above and a display panel displaying an image by utilizing the light from the lighting device. In this display device, the lighting device supplying light to the display panel decreases brightness difference between the light guide members, and thereby prevents uneven brightness. Thus, a display of high display quality can be realized.

The display panel is rectangular and the image is scanned along a short side of the display panel. The LEDs may be arranged in a line parallel along the short side of the display panel, and the light guide members may be arranged along an arrangement of the LEDs. The lighting device may further include a light source control unit configured to control driving of the LEDs to turn on the LEDs in a direction same as a scanning direction of the image on the display panel. In this case, the LEDs can be turned on in accordance with the image scan, and it also becomes possible to perform the area active control whereby output of the light from the light output surface of each light guide member is controlled individually. Thus, light control linked with a display screen can be performed, and thereby improved display quality can be obtained.

The display panel may be a liquid crystal panel. The display device as a liquid crystal display device may be applied to various purposes, including displays for televisions and personal computers, and is particularly suitable for large screens.

### Advantageous Effect of the Invention

According to the present invention, the capability of dissipating heat generated by the light source in an edge light type lighting device can be improved.

### BRIEF DESCRIPTION OF THE DRAWINGS

FIG. 1 is an exploded perspective view illustrating a schematic configuration of a television receiver according to the first embodiment of the present invention;

FIG. 2 is an exploded perspective view illustrating a schematic configuration of a liquid crystal display device included in the television receiver;

FIG. 3 is a cross sectional view illustrating a cross sectional configuration of the liquid crystal display device along a short side direction thereof;

FIG. 4 is a cross sectional view of the liquid crystal display device along a long side direction thereof;

FIG. 5 is a plan view illustrating a configuration of a back surface side of the liquid crystal display device; and

FIG. 6 is an enlarged cross sectional view of a main portion of the liquid crystal display device according to the second embodiment of the present invention along the short side direction thereof.

### BEST MODE FOR CARRYING OUT THE INVENTION

### First Embodiment

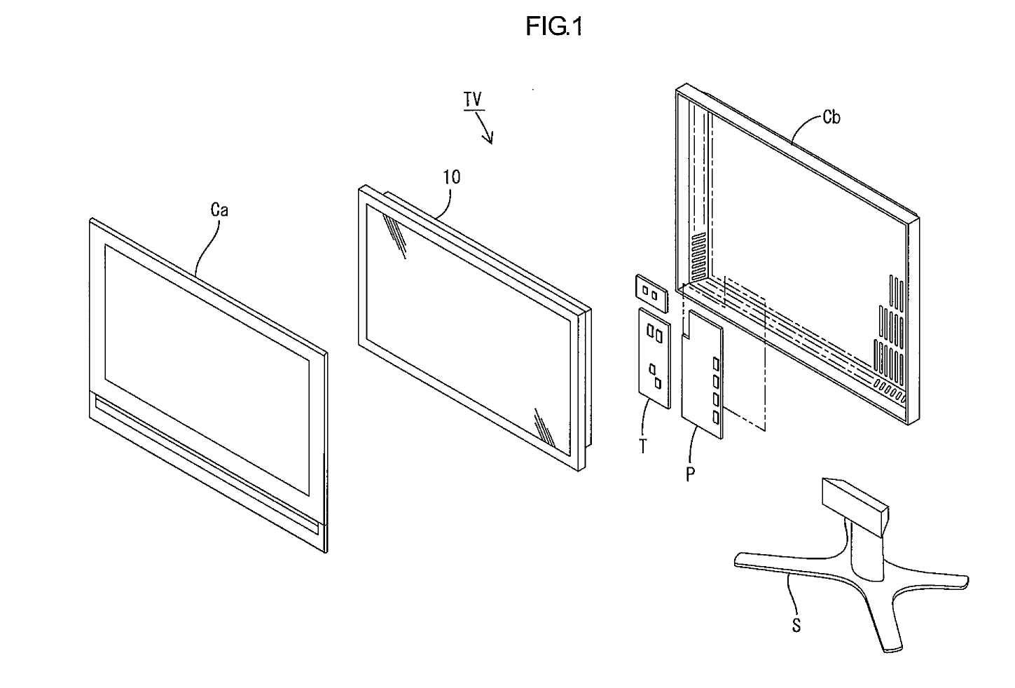

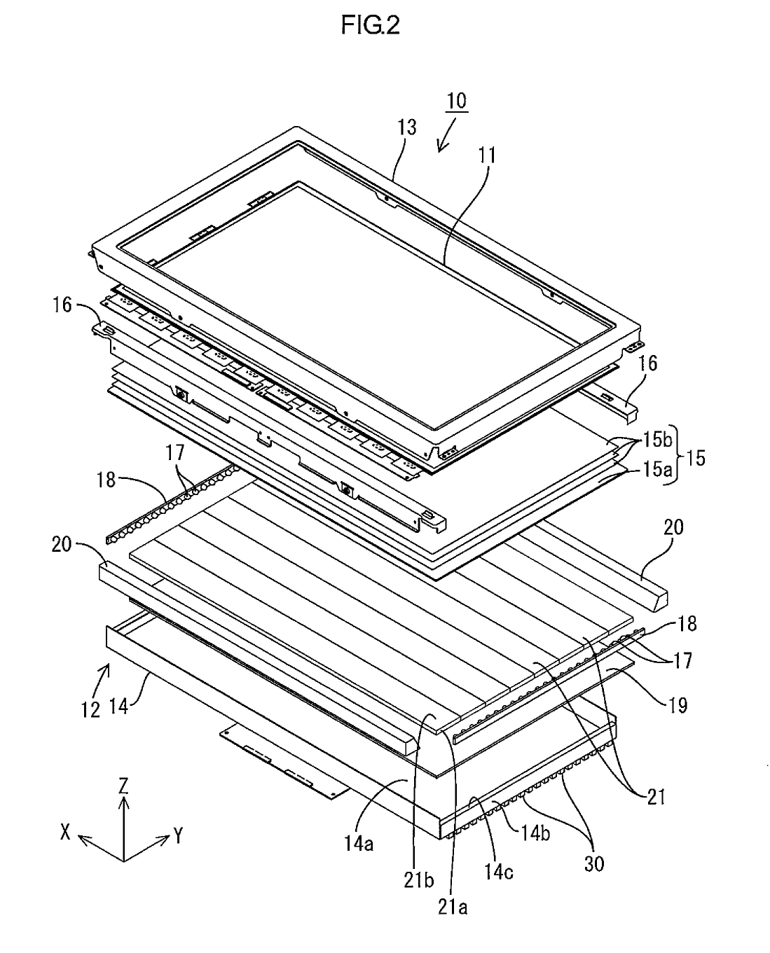

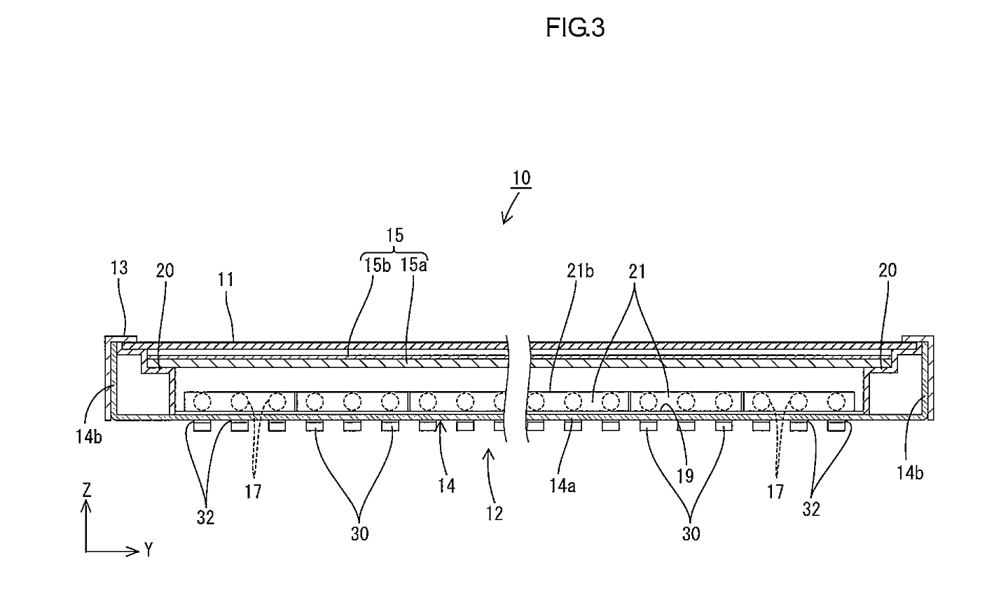

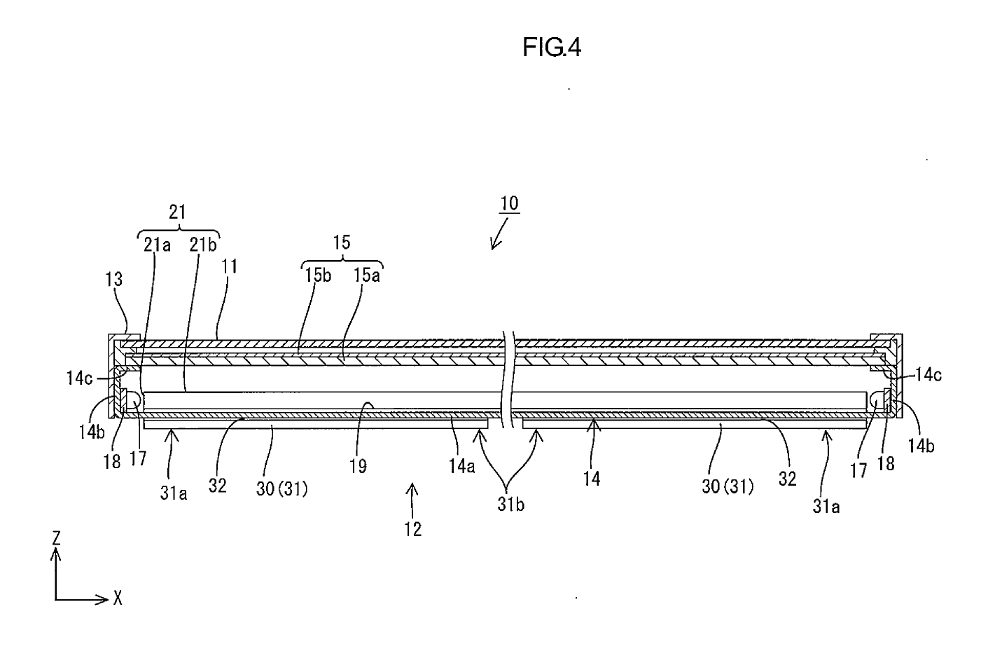

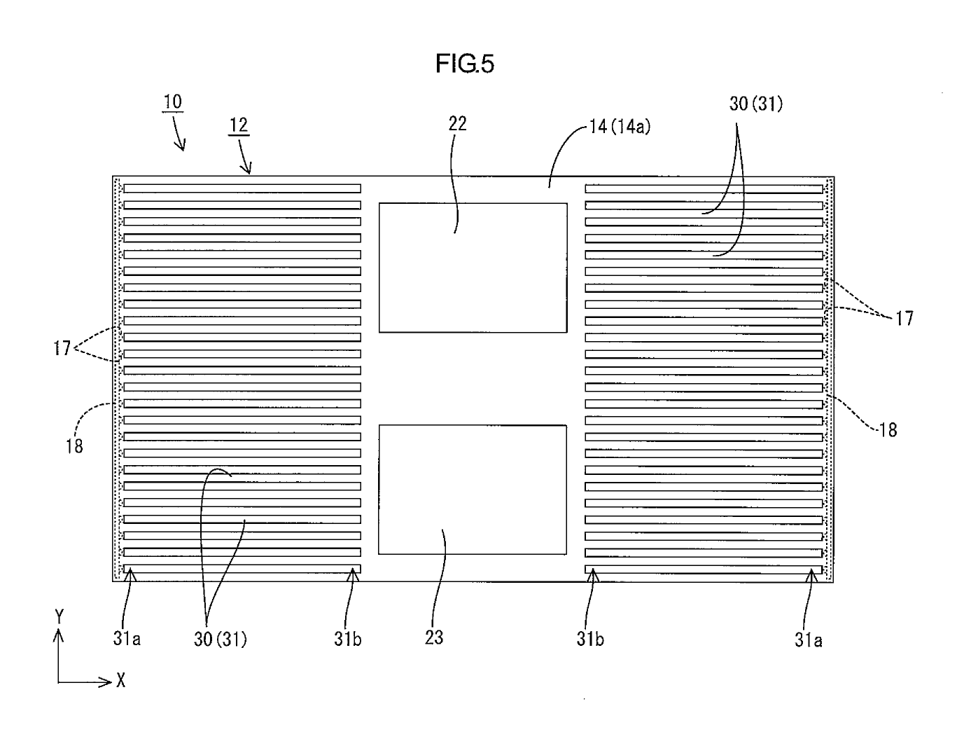

A first embodiment of the present invention will be described with reference to FIGS. 1 to 5. According to the present embodiment, a liquid crystal display device 10 will be described by way of example. FIG. 1 is an exploded perspective view illustrating a schematic configuration of a television receiver according to the present embodiment. FIG. 2 is an exploded perspective view illustrating a schematic configuration of the liquid crystal display device. FIG. 3 is a cross sectional view illustrating a cross sectional configuration of the liquid crystal display device along a short side direction thereof. FIG. 4 is a cross sectional view illustrating a cross sectional configuration of the liquid crystal display device along a long side direction thereof. FIG. 5 is a plan view of a back surface side of the liquid crystal display device. In some of the drawings, an X-axis, a Y-axis, and/or a Z-axis are shown. The directions of the axes are common throughout the drawings. An upper side and a lower side of FIG. 2 correspond to a front side (front surface side; light output side) and a back side (back surface side; an opposite side to the light output side), respectively.

As illustrated in FIG. 1, the television receiver TV according to the present embodiment includes the liquid crystal display device 10 (display device), front and back cabinets Ca and Cb between which the liquid crystal display device 10 is housed, a power source P, a tuner T, and a stand S. The liquid crystal display device 10 has a generally oblong square (rectangular) shape, and is housed in a vertically disposed manner. As illustrated in FIG. 2, the liquid crystal display device 10 includes a liquid crystal panel 11 as a display panel, and a backlight unit 12 (lighting device) as an external light source, which are integrally retained by a frame-shaped bezel 13 or the like.

As illustrated in FIG. 2, the liquid crystal panel 11 is rectangular in plan view, and includes a pair of glass substrates affixed to each other with a predetermined gap therebetween in which liquid crystal is enclosed. One of the glass substrates has switching components (for example, TFTs) connected to a source wiring and a gate wiring orthogonal to each other, pixel electrodes connected to the switching components, an alignment film, or the like. The other glass substrate has color filters including color sections of, for example, R (red), G (green), and B (blue) in predetermined arrangements, counter electrodes, an alignment film, or the like. On the outer sides of the grass substrates, polarizing plates are disposed.

Driving of the liquid crystal panel 11 is controlled by a liquid crystal panel control unit which is not shown. The liquid crystal panel control unit controls the driving of the liquid crystal panel 11 by outputting a control signal to the liquid crystal panel 11 on the basis of an output signal from an image signal processing unit which is not shown. The backlight unit 12 supplies light in accordance with the control by the liquid crystal panel control unit so that a desired image is displayed on a display screen of the liquid crystal panel 11. The image signal processing unit receives a signal, such as a television broadcast signal input to the tuner T via an antenna, performs image-processing of the input signal, and then outputs the processed signal to the liquid crystal panel control unit or the like.

Next, the backlight unit 12 will be described in detail. The backlight unit 12, as illustrated in FIG. 2, includes: a substantially box-shaped chassis 14 having an opening on a light output surface side (the side of the liquid crystal panel 11); a group of optical members 15 (including a diffuser plate 15a and a plurality of optical sheets 15b disposed between the diffuser plate 15a and the liquid crystal panel 11) disposed so as to cover the opening of the chassis 14; and frames 16 disposed along outer edge portions of the chassis 14 and holding the group of optical members 15 by sandwiching the outer edge portions of the optical members 15 between the frames 16 and the chassis 14. Further, the chassis 14 has therein: LEDs (Light Emitting Diodes) 17 as light sources; LED boards 18 on which the LEDs 17 are mounted; light guide members 21 guiding light from the LEDs 17 to the group of optical members 15 (liquid crystal panel 11); a reflection sheet 19 disposed on the back sides of the light guide members 21; and a pair of holders 20 on which edge portions of the optical members 15 and the liquid crystal panel 11 are placed. The backlight unit 12 has LED boards 18 with the LEDs 17 at both end portions thereof on the short sides. The light guide members 21 are disposed between the LED boards 18. Thus, the backlight unit 12 is the so-called edge light type (side light type). In the following, the constituent parts of the backlight unit 12 will be described in detail.

The chassis 14 may be made of a metal such as aluminum. As illustrated in FIGS. 3 and 4, the chassis 14 includes a bottom plate 14a having a rectangular shape similar to the liquid crystal panel 11, side plates 14b rising from the outer ends of the bottom plate 14a on each side thereof, and receiving plates 14c projecting inwardly from a pair out of the side plates 14b on the short sides. As a whole, the chassis 14 has a shallow, substantially box-like shape opening toward the front side. The chassis 14 has a long side direction corresponding to the X-axis direction (horizontal direction) and a short side direction corresponding to the Y-axis direction (vertical direction). On the receiving plates 14c of the chassis 14, the optical members 15 can be placed from the front side as will be described below.

As illustrated in FIG. 2, the optical members 15 have a rectangular shape in plan view, similar to the liquid crystal panel 11 and the chassis 14. As illustrated in FIG. 3, the outer edge portions of the optical members 15 is placed on the receiving plates 14c to cover the opening of the chassis 14. Therefore, the optical members 15 are disposed between the liquid crystal panel 11 and the light guide members 21. The optical members 15 include the diffuser plate 15a, which is disposed on the back side (the sides of the light guide members 21; opposite side to the light output side), and the optical sheets 15b, which are disposed on the front side (the side of the liquid crystal panel 11; light output side). The diffuser plate 15a includes a substantially transparent resin base substrate of a predetermined thickness. The base substrate has a number of diffusing particles dispersed therein to diffuse light transmitted therethrough. The optical sheets 15b have a sheet form of a smaller plate thickness than the diffuser plate 15a, and include a layer of three sheets (FIG. 2). Specific types of the optical sheets 15b include a diffuser sheet, a lens sheet, and a reflection type polarizing sheet, for example, which may be selected appropriately for use.

As illustrated in FIG. 2, the frames 16 extend along the long side direction of the chassis 14 and are attached to the chassis 14 on the long sides thereof. The frames 16 are configured to receive the edge portions of the liquid crystal panel 11 on the long sides thereof from the back side.

The LEDs 17 may include LED chips sealed on a board portion fixed on the LED boards 18 using a resin material, as illustrated in FIGS. 2 and 4. The LED chip mounted on the board portion has a one type of dominant light emission wavelength. Specifically, the LED chip emits a single color light of blue. The resin material sealing the LED chips include phosphors dispersedly included therein, and converting the blue light emitted from the LED chips into white light. Thus, the LEDs 17 can emit white light. The LEDs 17 have a light emitting surface on the side opposite to the side mounted on the LED boards 18, that is, are of the so-called “top type”.

As illustrated in FIGS. 2 and 4, the LED boards 18 have along and thin plate form extending along the short side direction of the chassis 14 (Y-axis direction), and are housed in the chassis 14 with a main plate surface parallel with the Y-axis direction and the Z-axis direction; namely, the main plate surface of the LED boards 18 is orthogonal to the plate surfaces of the liquid crystal panel 11 and the optical members 15. A pair of LED boards 18 is disposed in the chassis 14 at positions corresponding to the both end portions of the chassis 14 on the short sides thereof. Specifically, the pair of LED boards 18 is attached to an inner surface of the both side plates 14b of the chassis 14 on the short sides thereof. Thus, the LED boards 18 are disposed in an opposed manner to the both side surfaces of the light guide members 21 on the short sides thereof, as will be described later.

On the main plate surface of the LED boards 18, the LEDs 17 of the above configuration are surface-mounted. A plurality of LEDs 17 are arranged in a line (linearly) parallel to each other on the main plate surface of the LED boards 18 along the length direction thereof (Y-axis direction). Thus, it may be said that a plurality of LEDs 17 is disposed in a line parallel to each other at each of the both end portions of the backlight unit 12 on the short sides thereof. Because the pair of LED boards 18 is housed in the chassis 14 with the mounting surfaces of the LEDs 17 opposed to each other, the light emitting surfaces of the LEDs 17 mounted on the both LED boards 18 are opposed to each other, and thus the optical axis of the LEDs 17 substantially corresponding to the X-axis direction.

A base member of the LED boards 18 may be made of the metal such as an aluminum material, same as the chassis 14. On the surface of the base member, a wiring pattern (not shown) of a metal film, such as copper foil, is formed via an insulating layer. Via the wiring pattern, the LEDs 17 arranged in a line parallel to each other on the LED boards 18 are connected in series. The material of the base member of the LED boards 18 may include an insulating material such as ceramic.

The reflection sheet 19 illustrated in FIG. 2 may be made of a synthetic resin (such as foamed PET) with a white surface of high light reflectivity. The reflection sheet 19 is laid over substantially the entire area of the bottom plate 14a on the back sides of the light guide members 21, i.e., between the bottom plate 14a of the chassis 14 and the light guide members 21. The reflection sheet 19 is configured to reflect light output from the light guide members 21 toward the back side back into the light guide members 21.

The light guide members 21 are made of a substantially transparent (highly light transmissive) synthetic resin material (such as acrylic material) with a sufficiently high refractive index compared to air. The light guide members 21 are rectangular in plan view and have a plate form of a predetermined thickness. As illustrated in FIG. 2, a plurality (eight in FIG. 2) of light guide members 21 is disposed immediately below the liquid crystal panel 11 and the optical members 15 in the chassis 14, and is sandwiched between the pair of LED boards 18 disposed at the both end portions of the chassis 14 in the short side direction thereof. Specifically, the main plate surfaces of the light guide members 21 are directed toward the front side (the side of the optical members 15) and are disposed parallel to each other with a display surface of the liquid crystal panel 11. In addition, the light guide members 21 are arranged parallel to each other along the Y-axis direction, with their longitudinal direction aligned with the X-axis direction orthogonal to the direction in which the LEDs 17 are arranged in a line parallel to each other (Y-axis direction).

The light guide members 21 have the function of receiving the light emitted from the LEDs 17 in the X-axis direction, and causing the light as it travels within the light guide members 21 so as to direct the light upwardly toward the optical members 15 and exit therefrom (Z-axis direction). Both side surfaces of the light guide members 21 on the short sides thereof opposite to the LEDs 17 constitute light entrance surfaces 21a on which the light from the LEDs 17 makes incidence. Main plate surfaces of the light guide members 21 disposed on the front side (a side of the optical members 15) constitute light output surfaces 21b via which the light from the LEDs 17 is output (see FIGS. 2 and 4).

Next, the back surface side of the backlight unit 12 (the side of the bottom plate 14a of the chassis 14 opposite to the side with the LEDs 17 mounted) will be described with reference to FIG. 5. At a substantially central portion of the bottom plate 14a of the chassis 14, a power supply circuit board 22 supplying electric power to drive the LED boards 18, and a control circuit board 23 (corresponding to the light source control unit) controlling the driving of the LED boards 18 are attached. The power supply circuit board 22 and the control circuit board 23 are connected to the wiring pattern formed on the LED boards 18 so that the control circuit board 23 controls the driving of the LEDs 17 on the basis of a signal input from the image signal processing unit. According to the present embodiment, the image scan direction of the liquid crystal panel 11 is from the top to the bottom of the display screen (short side direction). The control circuit board 23 controls turning on and/or off of the individual LEDs 17 in the same direction in accordance with the scan.

On both sides of the power supply circuit board 22 and the control circuit board 23 on the bottom plate 14a of the chassis 14, heat pipes 30 extending from the short side edge portions of the chassis 14 along the long side direction are fixed. The heat pipes 30 is formed by enclosing a small amount of working fluid in hollow main body portions 31 of a substantially square pillar outer shape in a vacuum, and then hermetically sealing the main body portions 31. The main body portions 31 are made of a metal with high heat conductivity, such as copper or aluminum. The inner walls of the main body portions 31 have grooves or wicks causing a capillary phenomenon, which are not shown. The working fluid sealed in the main body portions 31 may include a highly volatile alternative Freon gas or the like. One end of the main body portions 31 overlapping with the LEDs 17 constitutes heat absorbing portions 31a, and the other end closer to the circuit boards 22 and 23 constitutes heat dissipating portions 31b.

The heat pipes 30 are fixed on the bottom plate 14a of the chassis 14 on the back surface side with a double-sided tape 32 affixed to one side surface of the main body portions 31. The double-sided tape 32 is made of a high heat conductivity material, for example, similar to the one used for fixing the LED boards 18 on the chassis 14. The heat pipes 30 are affixed along the X-axis direction such that the heat absorbing portions 31a overlap with the LEDs 17 on the short sides of the chassis 14 and the heat dissipating portions 31b extend to the central side of the bottom plate 14a of the chassis 14. Thus, the heat pipes 30 are arranged parallel to each other on the chassis 14 to be along the Y-axis direction on both sides of the power supply circuit board 22 and the control board 23. According to the present embodiment, each one of heat pipes 30 is provided for each of the LEDs 17.

An operation of the present embodiment with the above structure will be described below. A signal such as a television broadcast signal is input to the image signal processing unit via the antenna and the tuner T. After image-process by the image signal processing unit, the resultant output signal is output to the liquid crystal panel control unit and the control circuit board 23. Thus, the driving of the liquid crystal panel 11 is controlled by the liquid crystal panel control unit, and the driving of the LEDs 17 is individually controlled by the control circuit board 23. Accordingly, the liquid crystal panel 11 is irradiated with illumination light from the backlight unit 12 to display a predetermined image on the liquid crystal panel 11.

Specifically, if the LEDs 17 are turned on, the light emitted by the LEDs 17 makes incidence on the light entrance surfaces 21a of the light guide members 21. The light entering via the light entrance surfaces 21a is reflected by the reflection sheet 19 or totally reflected by boundary surfaces of the light guide members 21 such that the light travels effectively inside the light guide members 21, and thereafter output via the light output surfaces 21b. The light exit surface of the backlight unit 12 is configured with the group of the light output surfaces 21b of the light guide members 21. Thus, planar light exits from the light exit surface of the backlight unit 12 as a whole.

According to the present technology, each of the light guide members 21 is optically independent from each other. Driving of each LED 17 is controlled along the image scan direction, i.e., from an upper portion to a lower portion of the chassis 14 along the short side direction. Thus, output of the light from each light output surface 21b can be individually controlled in accordance with the image scan. Accordingly, power consumption can be decreased and visual recognition of the persistence of vision on the display screen can be suppressed. If the image to be displayed contains a black display region and a non-black display region, it is controlled to turn on only the LEDs 17 that face the light entrance surfaces 21a of the light guide members 21 having the light output surfaces 21b that overlap the non-black display region in a plan view. Accordingly, light is output from the corresponding light output surfaces 21b. On the other hand, it is controlled to turn off or keep off the LEDs 17 that face the light entrance surfaces 21a of the light guide members 21 having the light output surfaces 21 that overlap the black display region in a plan view. Accordingly, the light is not output from the corresponding light output surfaces 21b. This ensures great difference in brightness between the black display region and the non-black display region, thus providing a high contrast performance. Further, such control (area active control) leads to not only high display quality but also low power consumption.

Next, an operation of the heat pipes 30 will be described. The heat generated by the LEDs 17 is conducted via the chassis 14 to the heat absorbing portions 31a of the heat pipes 30 and further to the working fluid in the main body portions 31. The working fluid is evaporated by the conducted heat, and moves toward the heat dissipating portions 31b of lower temperature than in the heat absorbing portions 31a due to the capillary action by the wicks or the like provided on the inner walls of the main body portions 31. The working fluid that has moved to the heat dissipating portions 31b dissipates heat (i.e., is cooled) and is thereby condensed, thus returning to the liquid phase state. The working fluid back in the liquid phase flows back to the heat absorbing portions 31a again by the capillary action. This process is repeated, whereby the heat is transmitted via the working fluid from the heat absorbing portions 31a to the heat dissipating portions 31b, so that the heat of the LEDs 17 is dissipated through the heat dissipating portions 31b of the heat pipes 30. In this way, the heat generated by the LEDs 17 is dissipated on the central portion side of the chassis 14 via the working fluid. Thus, the heat generated by the LEDs is distributed. By thus cooling the areas around the LEDs 17 by using the heat pipes 30, decrease in light emission efficiency or thermal degradation of the LEDs 17 can be prevented.

As described above, the backlight unit 12 according to the present embodiment includes: the plurality of LEDs 17; the chassis 14 housing the LEDs 17; the light guide members 21 housed in the chassis 14 and including the light entrance surfaces 21a opposed to the LEDs 17 and receiving the light from the LEDs 17, and the light output surfaces 21b outputting the light; and the plurality of heat pipes 30 fixed on the chassis 14. The chassis 14 includes the substantially rectangular bottom plate 14a, and the LEDs 17 are arranged in a line parallel to each other at the both end portions of the bottom plate 14a of the chassis 14 on the short sides thereof. The heat pipes 30 are elongated with one end overlapping with the LEDs 17 and the other end extending to the central side of the chassis 14 with respect to the longitudinal direction.

Thus, in the configuration according to the present technology, the elongated heat pipes 30 are disposed with one end thereof overlapping with the LEDs 17 and the other end extending to the central portion of the chassis 14 with respect to the longitudinal direction thereof to facilitate the heat dissipation. Namely, the heat pipes 30 are configured to absorb the heat generated by the LEDs 17 via the heat absorbing portions 31a overlapping with the LEDs 17, and dissipate the heat efficiently by transferring the absorbed heat to the heat dissipating portions 31b on the central side of the chassis 14 where the temperature is lower than in the heat absorbing portions 31a. In addition, by providing a plurality of heat pipes 30, the amount of heat dissipated by each one of heat pipes 30 is reduced and the circulation efficiency of the working fluid in the heat pipes 30 is increased, and thereby the cooling efficiency for the individual LEDs 17 can be improved.

Furthermore, the heat pipes 30 constituting the cooling members are operable without electric power by utilizing the phase change of the working fluid. Therefore, low power consumption can be achieved compared with the case where a blower fan or the like is utilized.

The heat pipes 30 are fixed on the surface of the bottom plate 14a of the chassis 14 opposite to the surface on which the LEDs 17 are disposed. Thus, space within the backlight unit 12 is saved. When the heat pipes 30 absorb the heat generated by the LEDs 17 and dissipate some of the heat directly to the outside air, higher air circulation efficiency can be obtained on the outside of the backlight unit 12 than inside thereof. Thus, a high heat dissipating capability can be obtained.

The heat pipes 30 are fixed to the chassis 14 with the double-sided tape 31 of high heat conductivity. In this configuration, the heat pipes 30 are easily installed to provide high installation workability. The heat conducted to the heat pipes 30 is dissipated not only via the dissipation mechanism of the heat pipes 30, but also via the surface portion of the heat pipes 30 fixed to the chassis 14 with the double-sided tape 31 to the chassis 14. Further, by fixing the heat pipes 30 with the double-sided tape 31, a large area of contact between the heat pipes 30 and the chassis 14 via the double-sided tape 31 is ensured, compared to other fixing means. Thus, the heat dissipating capability of the heat pipes 30 via the chassis 14 is further improved.

The LEDs 17 are mounted on the LED boards 18 extending along the direction in which the light guide members 21 are arranged parallel to each other. The mounting of the LEDs 17 on the LED boards 18 simplifies the installation of the LEDs 17 and the wiring between the LEDs 17.

A plurality of light guide members 21 is arranged parallel to each other along the direction in which the LEDs 17 are arranged in a line parallel to each other. In this configuration, output of the light is independently controlled for each light guide members 21 in accordance with the drive control of the LEDs 17. Thus, the area active control can be performed per light guide member 21.

The liquid crystal panel 11 is rectangular, and an image scan is performed along the short side direction thereof. In the backlight unit 12, the LEDs 17 are arranged in a line parallel to each other along the short side direction of the liquid crystal panel 11 (bottom plate 14a of the chassis 14), and a plurality of light guide members 21 are arranged parallel along the line direction of the LEDs 17. The backlight unit 12 according to the present embodiment further includes the control circuit board 23 controlling driving of the LEDs 17 such that LEDs 17 are turned on in the same direction as the image scan direction on the liquid crystal panel 11. In this configuration, the LEDs 17 can be turned on in accordance with the image scan, and which leads to the area active control whereby output of the light from the light output surfaces 21b of the individual light guide members 21 is controlled. Thus, a light control linked with display screen can be performed, and thereby improved display quality can be obtained.

### Second Embodiment

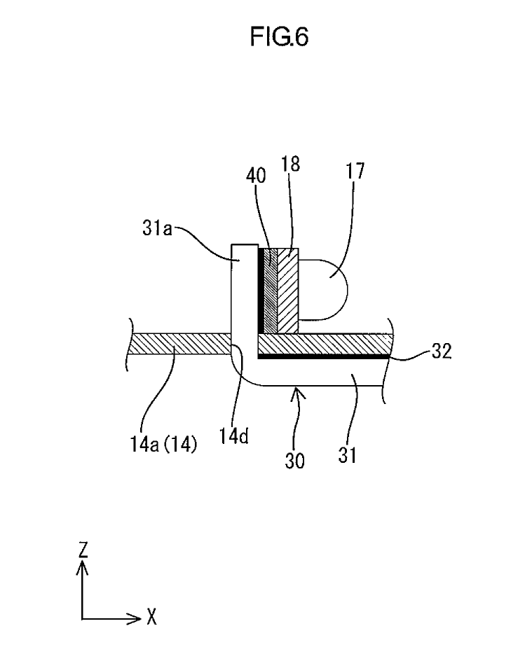

Next, a second embodiment of the present invention will be described with reference to FIG. 6.

The present embodiment differs from the first embodiment in that a heatsink 40 is connected to the LED boards 18, and the heat absorbing portions 31a of the heat pipes 30 are connected to the heatsink 40. The present embodiment is similar to the first embodiment in other respects and repetitive description will be omitted. FIG. 6 is an enlarged cross sectional view around the LEDs 17 illustrating a cross sectional configuration of the liquid crystal display device 10 taken along the short side direction.

As illustrated in FIG. 6, the heatsink 40 is connected to the surface of the LED boards 18 opposite to the LED 17 mounting surface. The heatsink 40 is a plate member of a metal with high heat conductivity. One plate surface of the heatsink 40 is fixed in contact with the LED boards 18. To the other surface, the heat absorbing portions 31a of the heat pipes 30 are affixed with the double-sided tape 32. The bottom plate 14a of the chassis 14 has an insertion holes 14d closer to the end thereof than the LED boards 18 and the heatsink 40, through which the heat pipes 30 are inserted. The heat pipes 30 are inserted through the insertion holes 14d with the main body portions 31 thereof bent to be along the back surface of the bottom plate 14a of the chassis 14.

In this configuration, the heat generated by the LEDs 17 is dissipated by being conducted first to the heatsink 40 connected to the LED boards 18 and then to the plurality of heat pipes 30 connected to the heatsink 40. Connection of the heat pipes 30 to the heatsink 40 can further improve the heat dissipating efficiency of the heatsink 40. Thus, the heat dissipating capability with regard to the heat from the LEDs 17 can be improved.

### Other Embodiments

The present invention is not limited to any of the foregoing embodiments with reference to the drawings. The technical scope of the present invention may include the following embodiments.

(1) While in the foregoing embodiments, the LEDs 17 are disposed at the both end portions of the backlight unit 12 on the short sides thereof, the present invention is not limited to such a configuration, and may include a configuration in which the LEDs 17 are disposed at one of the end portions of the backlight unit 12 on the short sides thereof.

(2) While in the foregoing embodiments, the outer shape of the heat pipes 30 is a square pillar, the present invention is not limited to such a configuration, and may include a configuration in which, for example, the heat pipes 30 have an adhesive surface with respect to the chassis 14 and have a semicircular, elliptical, or trapezoidal cross section.

(3) While in the second embodiment, the heatsink 40 is a plate member fixed in contact with the surface of the LED boards 18 opposite to the LEDs mounting surface, the present invention is not limited to such a configuration and may include a configuration in which, for example, the heatsink 40 has a plurality of fin structures. Such a configuration can improve the heat dissipating efficiency by means of the heatsink 40.

(4) While in the foregoing embodiments, a plurality of LEDs 17 is provided with respect to each one of the light entrance surfaces 21a of the light guide members 21, the present invention is not limited to such a configuration and may include a configuration in which, for example, one LED 17 is provided for each of the light entrance surfaces 21a of the light guide members 21. By thus providing the light guide members 21 individually corresponding to each one of the LEDs 17, which is the minimum unit for the drive control of the LEDs 17, the effect of the area active control can be maximized.

(5) While in the foregoing embodiments, the respective light guide members 21 have the same size, the present invention is not limited to such a configuration, and may include a configuration in which, for example, the respective light guide members 21 have different sizes such that the area of the light output surfaces 21b of the light guide members 21 located at the central position of the chassis 14 corresponding to the central portion of the display screen is relatively small compared to the area of the light output surfaces 21b of the light guide members 21 located at the both end portions of the chassis 14. In this configuration, cost reduction can be achieved while an improved contrast performance can be obtained in the screen central portion that is easily visually recognizable.

(6) While in the foregoing embodiments, the light guide members 21 have a plate form, the present invention is not limited to such a configuration, and may include a configuration in which, for example, the light guide members 21 have other forms, such as a triangular prism or columnar form.

(7) While in the foregoing embodiments, the LEDs 17 include a LED chip emitting the single color light of blue, the LEDs 17 may include a LED chip emitting the single color light of violet. In another example, an LED may include three types of LED chips respectively emitting the single color light of R, G, and B.

(8) While in the foregoing embodiments the LEDs 17 are mounted on the LED boards 18, it is also possible to use LEDs disposed on a film substrate.

(9) In the foregoing embodiments, TFTs are used as the switching components of the liquid crystal display device 10. However, the present application is applicable to the liquid crystal device using switching components other than TFTs (such as thin-film diodes (TFD)), and also to black-and-white display as well as color display.

(10) In the foregoing embodiments, the liquid crystal display device 10 includes the liquid crystal panel 11 as a display panel by way of example. However, the present invention may be applied to display devices using other types of display panel.

(11) In the foregoing embodiments, the television receiver 10 includes the tuner T by way of example. However, the present invention may be applied to display devices without a tuner.

### EXPLANATION OF SYMBOLS

10: Liquid crystal display device (display device)
11: Liquid crystal panel (display panel)
12: Backlight unit (lighting device)
14: Chassis
15: Optical member
17: LED
18: LED board
19: Reflection sheet
21: Light guide member (light guide member)
21a: Light entrance surface
21b: Light output surface
30: Heat pipe
31: Main body portion
31a: Heat absorbing portion
31b: Heat dissipating portion
TV: Television receiver

1. A lighting device comprising:
a plurality of LEDs;
a chassis including substantially a rectangular bottom plate and housing the LEDs such that the LEDs are arranged along an at least a short side of the bottom plate;
a light guide member housed in the chassis and including a light entrance surface through which light from the LEDs enters and a light exit surface from which the light exits, the light guide member being provided such that the light entrance surface faces the LEDs; and
a plurality of cooling members fixed on the chassis and formed in an elongated shape having one end that is provided to overlap one of the LEDs and another end that is provided in a middle portion of the chassis in a longitudinal direction thereof.

2. The lighting device according to claim 1, wherein the cooling members are heat pipes.

3. The lighting device according to claim 1, wherein the cooling members are fixed on a surface of the bottom plate that is opposite to a surface of the bottom plate on which the LEDs are arranged.

4. The lighting device according to claim 1, wherein the cooling members are fixed to the chassis with a double-sided tape having high heat conductivity.

5. The lighting device according to claim 1, wherein the LEDs are arranged on each short-side end portion of the chassis in a line along a short side of the chassis.

6. The lighting device according to claim 1, further comprising:
an LED board on which the LEDs are mounted; and
a heatsink connected to the LED board, wherein:
the light guide member includes a plurality of light guide members that are arranged along an arrangement of the LEDs;
the LED board extends along an arrangement of the light guide members; and
the heatsink is connected to the one end of the cooling member that is close to the LEDs.

7. The lighting device according to claim 1, wherein the light guide member includes a plurality of light guide members that are arranged along an arrangement of the LEDs.

8. The lighting device according to claim 7, wherein each one of the LEDs is provided for each light entrance surface of the light guide members.

9. A display device comprising:
the lighting device according to claim 1; and
a display panel displaying an image by utilizing light from the lighting device.

10. The display device according to claim 9, wherein:
the display panel is rectangular and the image is scanned along a short side of the display panel;
the LEDs are arranged in a line along the short side of the display panel;
the light guide member includes a plurality of light guide members that are arranged along an arrangement of the LEDs;
the lighting device further includes a light source control unit configured to control driving of the LEDs to turn on the LEDs in a direction same as a scanning direction of the image on the display panel.

11. The display device according to claim 9, wherein the display panel is a liquid crystal panel with liquid crystal enclosed between a pair of substrates.

12. A television receiver comprising the display device according to claim 9.
